(19) United States
(12) Patent Application Publication
(10) Pub. No.: US 2004/0021847 A1
(43) Pub. Date: Feb. 5, 2004

(54) Method for manufacturing screen plate and screen plate

(76) Inventor: Hideharu Yoshizawa, Ota-ku (JP)

Correspondence Address: JORDAN AND HAMBURG LLP, 122 EAST 42ND STREET, SUITE 4000, NEW YORK, NY, 10168, US

(21) Appl. No.: 10/614,640

(22) Filed: Jul. 7, 2003

(30) Foreign Application Priority Data
Jul. 8, 2002 (JP) 2002-198157
Jun. 10, 2003 (JP) 2003-165437

(51) Int. Cl. G03B 27/32

(52) U.S. Cl. 355/77

(57) ABSTRACT

A method for manufacturing of a screen plate including the screen printing plate, screen printing plate using an image, electronic stencil and the like in order to print the image to printed object, includes a step for preventing generating of a moire including moire fringes and a spot produced by piling up the formation which the point and line are distributed regularly and geometrically, one of setting a dot angle of printing colors needed for printing of the screen plate at a predetermined angle and matching a screen angle with the dot angle; and a step for forming the screen plate including a screen and a frame stretching the screen so that it can prevent certainly the generating of moire so that it can print a picture with a lively motion and with high resolution, and it can be manufactured the high utility value of a screen plate in the optimal state.

### BACKGROUND OF THE INVENTION

This invention relates to the method for manufacturing of a screen plate and the screen plate that prevent generating of moire such as moire fringes, spot and so on in a screen printing.

Conventionally, the number of lines of a screen are 300 lines/inch in the case of the printed matter of a screen-printing, and the screen angle between each color plate is set into 30 degree's difference. The color of yellow is set at 15 degree's difference, for example, 0 degree, 60 degree and so on.

In the conventional manufacture method of the screen plate, the moire such as moire fringes and a spot is generated in the relation with the number of screen lines and a screen angle.

### SUMMARY OF THE INVENTION

In light of the forgoing, it is an object of the invention to provide a the method for manufacturing of a screen plate and the screen plate which can prevent certainly the generating of moire and print a picture with a lively motion and with high resolution. It is another object of the invention to provide a method for manufacturing of a screen plate and the screen plate that can be manufactured the high utility value of a screen plate in the optimal state.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is a flow chart showing a first embodiment of the present invention;

FIG. 2 is an explanation view of a degree of a screen;

FIG. 3 is an explanation view of another degree of a screen;

FIG. 4 is an explanation view of a step for forming a screen plate;

FIG. 5 is an explanation view showing the way in which a T-shirt is printed;

FIG. 6 is an explanation view showing the way in which a can is printed;

FIG. 7 is a flow chart showing a second embodiment of the present invention;

FIG. 8 is an explanation view of a process for forming a screen plate;

FIG. 9 is a flow chart showing a third embodiment of the present invention;

FIG. 10 is an explanation view when the pattern as a manuscript is read with a scanner;

FIG. 11 is a view about a moire prevention process;

FIG. 12 is an explanation view for performing from a digital decomposition to a monochrome-two gray scale;

FIG. 13 is an explanation view for performing from gray scale conversion to a finishing;

FIG. 14 is a reference view for receiving the data of picture;

FIG. 15 is a flow chart showing a fourth embodiment of the present invention;

FIG. 16 is an explanation view of a step for selecting;

FIG. 17 is an explanation view of a step for selecting a color;

FIG. 18 is an explanation view of a step for performing the spot color;

FIG. 19 is an explanation view of a step for converting;

FIG. 20 is an explanation view of a step for processing a frame;

FIG. 21 is a flow chart showing a fifth embodiment of the present invention;

FIG. 22 is an explanation view of a step for processing an operation;

FIG. 23 is an explanation view of a step for saving;

FIG. 24 is an explanation view of a step for amending;

FIG. 25 is a flow chart showing a sixth embodiment of the present invention;

FIG. 26 is an explanation view of a step for forming an under base white;

FIG. 27 is an explanation view of a step for forming a top white;

FIG. 28 is an explanation view of a step for forming an under base white;

FIG. 29 is an explanation view of a step for forming an under base white;

FIG. 30 is an explanation view of a step for forming a top white;

FIG. 31 is an explanation view of a step for converting an index color;

FIG. 32 is an explanation view of a step for determining the number of colors;

FIG. 33 is an explanation view of a step for adding the colors;

FIG. 34 is an explanation view of a step for processing the index color;

FIG. 35 is an explanation view of a step for reversing; and

FIG. 36 is an explanation view of a step for converting.

### DETAILED DESCRIPTION OF THE PREFERRED EMBODIMENTS

Preferred embodiments of the present invention are described in more detail below with reference to the accompanying drawings.

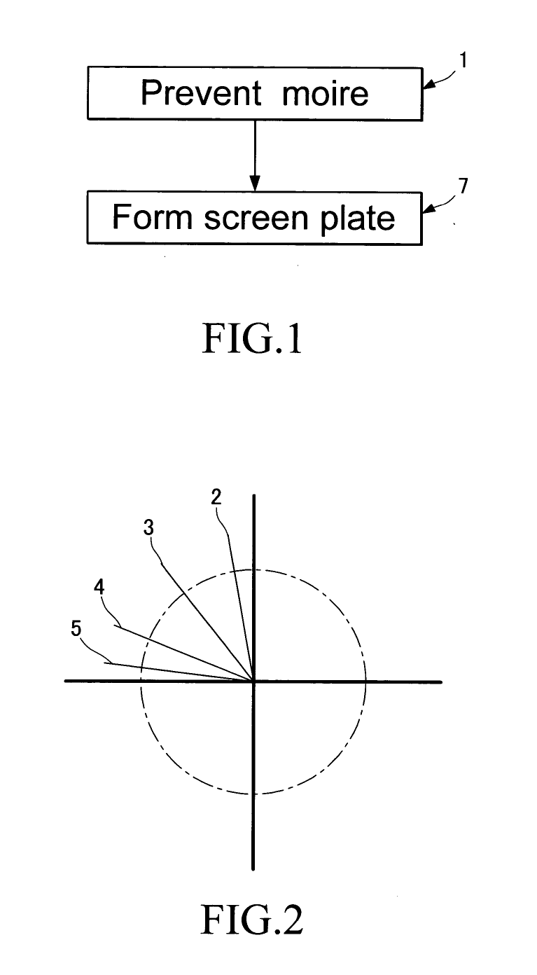

An understanding of the present invention may be best gained by reference to FIGS. 1-6. In the method for manufacturing the screen plate printed as a net positive by the same method as usual after the manuscript is processed suitably and changed to the image data which can proceed by using the scanners X for plate-making, computer or the like and is produced as a separation net negative (net negative) and is proceeded to reverse the net negative adhesively, the numeral 1 shows a step for preventing a moire. In a first phenomenon part shown in a graph having a X and Y axles for example, as shown in FIG. 2, a screen angle of cyan 2 is set at 79 to 81 degrees, preferably 80 degree; the screen angle of black 3 is set at 51 to 53 degrees, preferably 52 degree; a screen angle of magenta 4 is set at 21 to 23 degrees, preferably 22 degree; and a screen angle of yellow 5 is set at 6 to 8 degrees, preferably 7 degree. Then spots 6 that are formed in the shape of an ellipse are used.

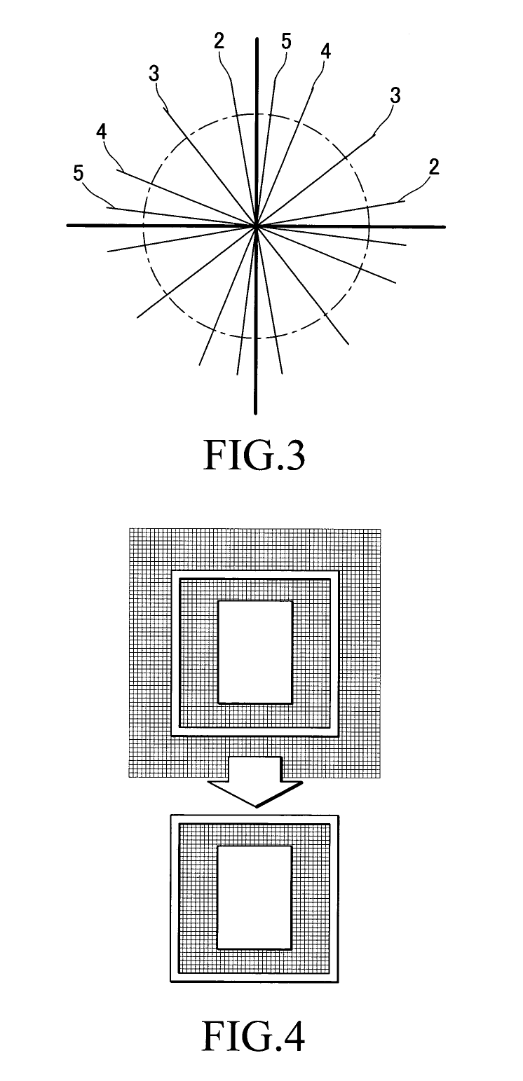

In addition, each screen angle in the first phenomenon part which is set up in the first embodiment is also positioned at a second, third and fourth phenomenon parts as an opposite angle or a symmetrical angle. For example, as shown in FIG. 3, in the second phenomenon part, cyan 2 is set up at 170 degrees; black 3 is set up at 142 degrees; magenta 4 is set up at 112 degrees; and yellow 5 is set up at 97 degrees.

Moreover, the screen angle that prevents the moire generating of the spots etc. may be, for example, set up at approximately 6 to 8 degrees of cyan 2; approximately 66 to 68 degrees of black 3; approximately 126 to 128 degrees of magenta 4; and approximately 170 to 173 degrees of yellow 5. Also each color's screen angle that prevents to generate the moire can be set up freely or alternatively.

The numeral 7 shows a step for forming a screen plate 11. As shown in FIG. 4, the screen plate 11 includes a screen 9 having a positive film 8 having an arbitrary numbers of screen lines, 240 lines in this embodiment and a frame 10 made from aluminum, stretching the screen 9 in the level and the perpendicular state by the same method as usual. In this embodiment, the screen 9 is made from the Dacron. Also the frame 10 may be formed in a wooden frame, and the screen 9 may be used silk as the same as usual, nylon, polyester, and stainless steel and the like.

In addition, the screen 9 is determined in consideration of a printing machine, ink, etc., although the screen about four times as the number of lines is used basically. For example, the number of the screen lines per inch of the dot screen is approximately 120 mesh (lines) in the case of 30 lines; approximately 200 meshes in the case of 50 lines; and approximately 240 meshes in the case of 60 lines.

In this embodiment, the dot is formed in the shape of an ellipse and is used. Moreover the dot may be formed in the shape of a circle, lozenge, square, line, cross and the like. Furthermore, according to printed matter, the good shape and favorite shape may be used alternatively.

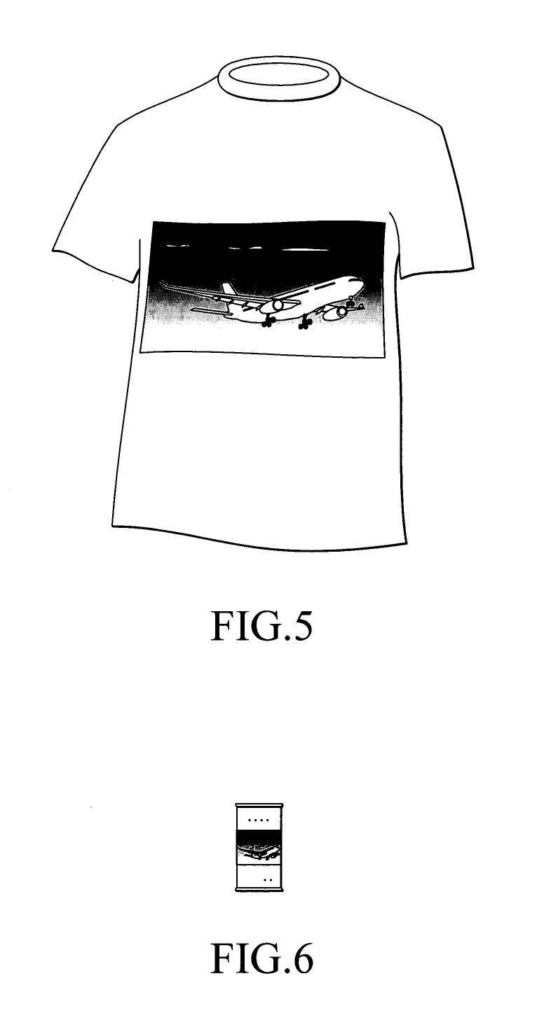

The screen plate 11 produced by the above manufacture method of the screen plates is used in order to print to the cloth such as a towel and clothes such as a T-shirt, a trainer, etc., a T-shirt in this embodiment as shown in FIG. 5, by a roller printing and the like.

With the adjusted screen angle, the generating of moire is prevented efficiently without interfering the dot and mismatching the screen angle in dot decomposition, and the high quality product can be obtained.

In addition, although T-shirt as the printed object is explained in this embodiment, the printed objects including sheet material and processed goods which are processed with papers, fiber, resin material, metal material, ceramics, glass, etc. may be used. For example, it may be printed on the surface of the can as shown in FIG. 6.

Moreover, the “Dragonfly” which is a mark for arranging direction of a pattern with the film 8 as usual is given to arbitrary positions.

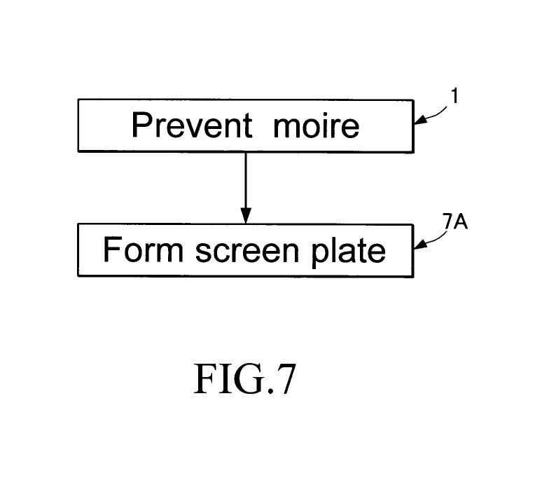

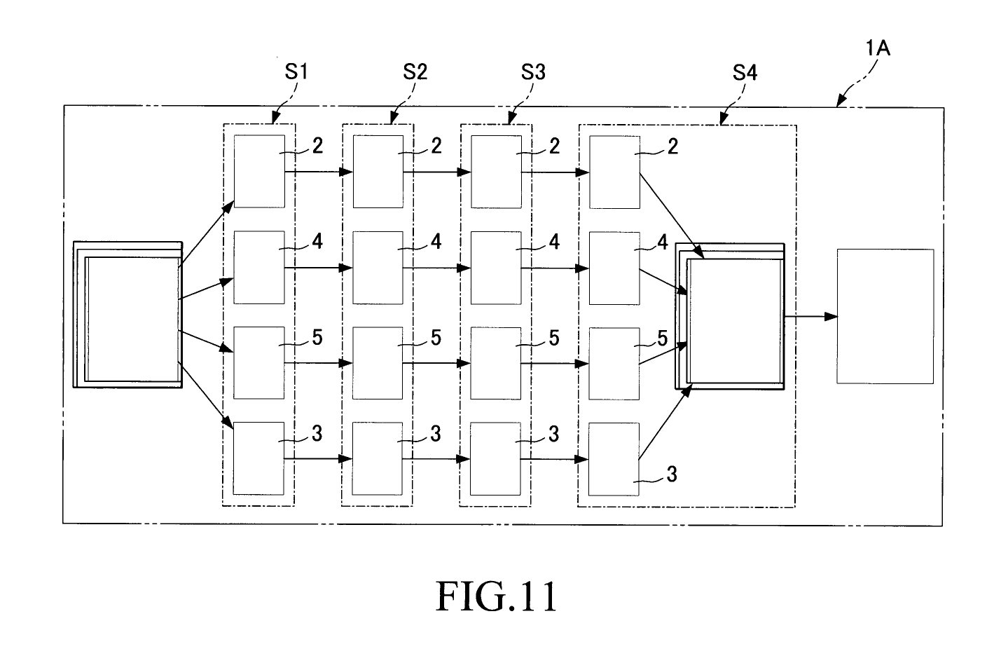

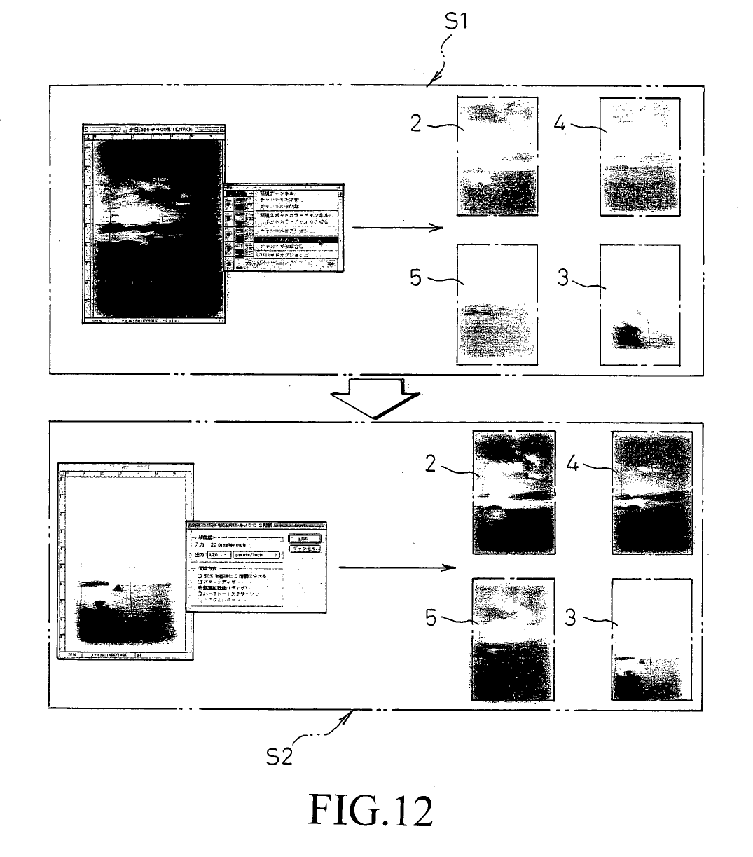

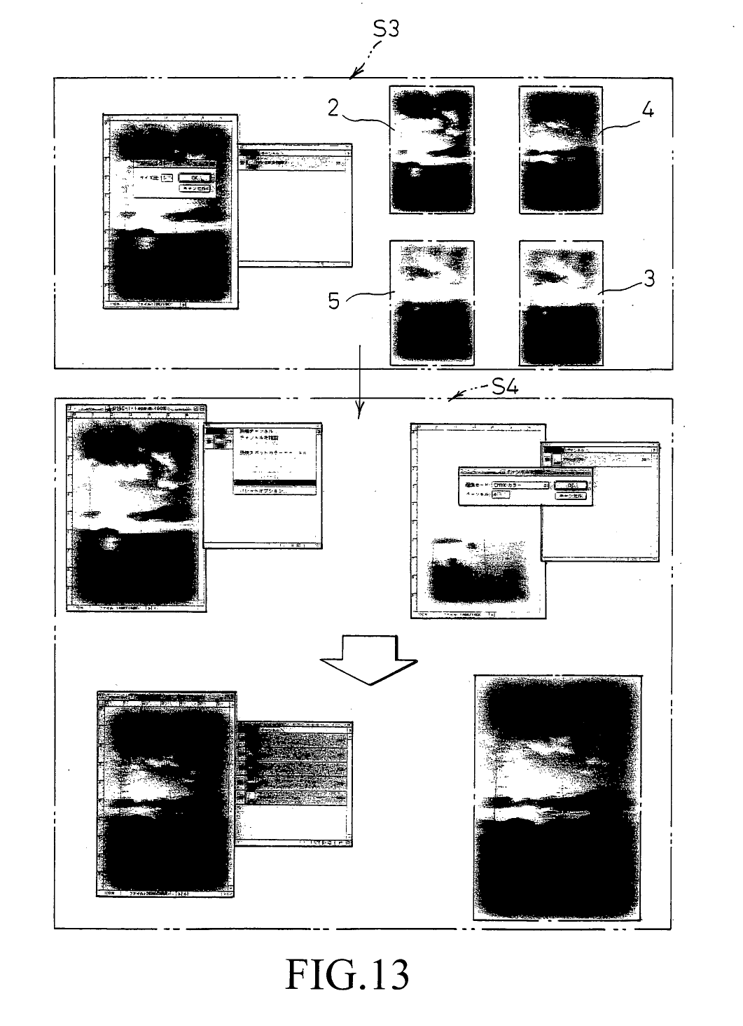

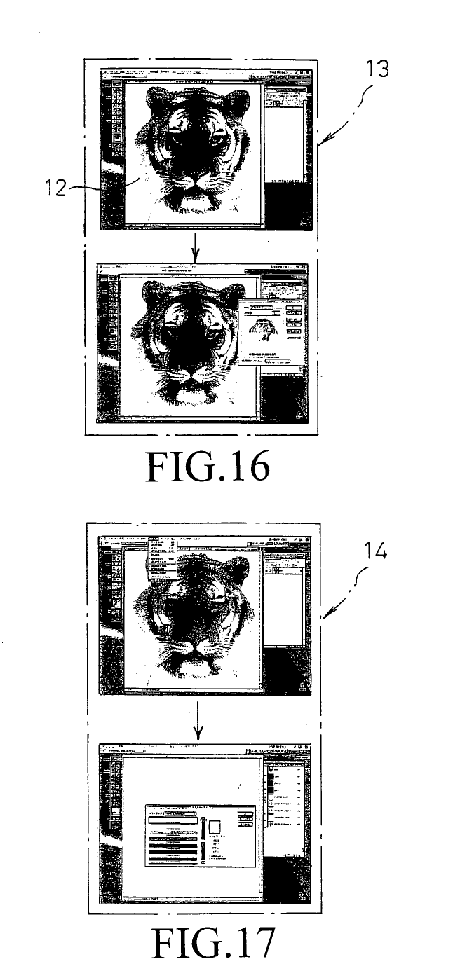

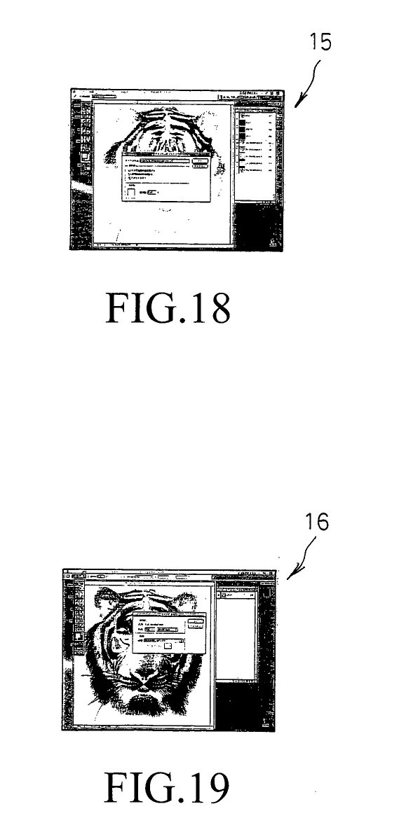

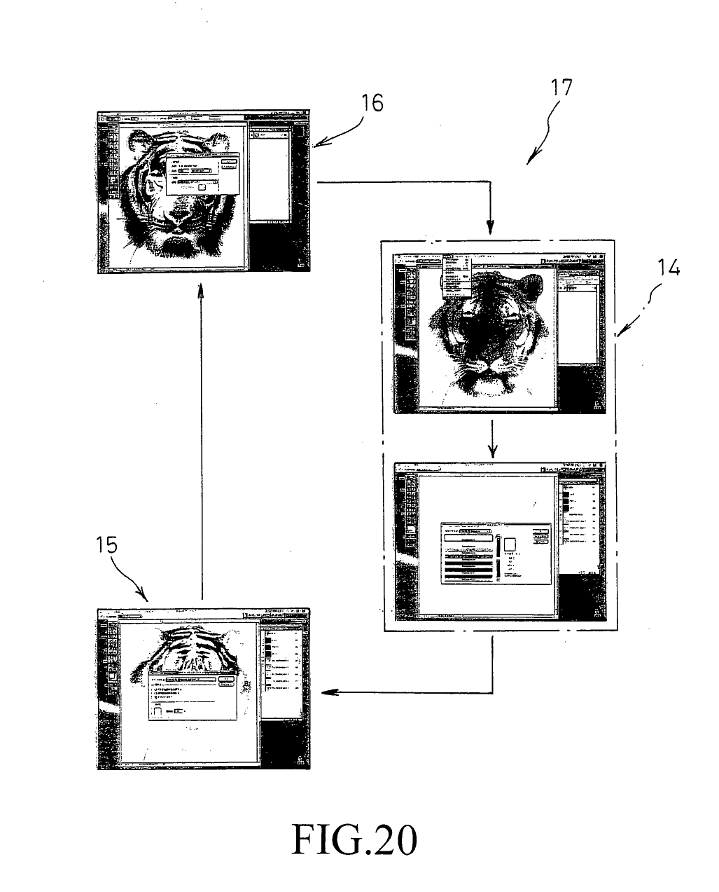

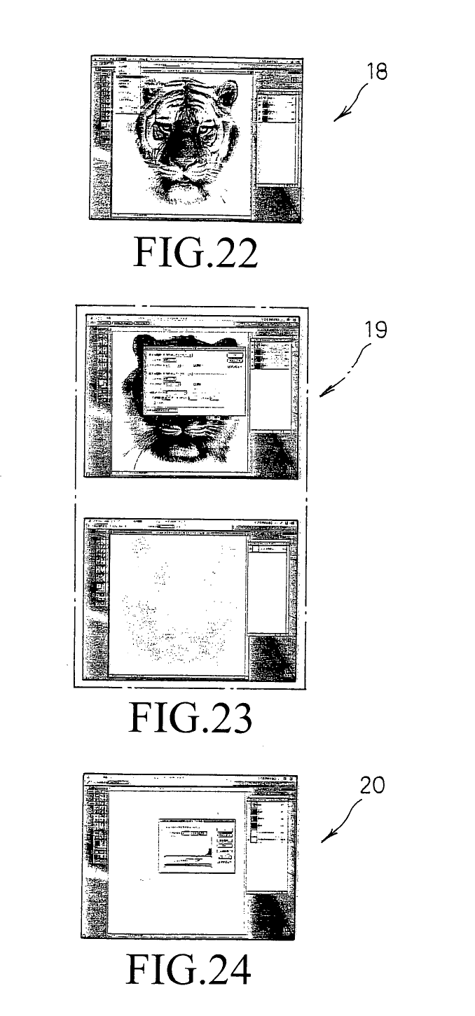

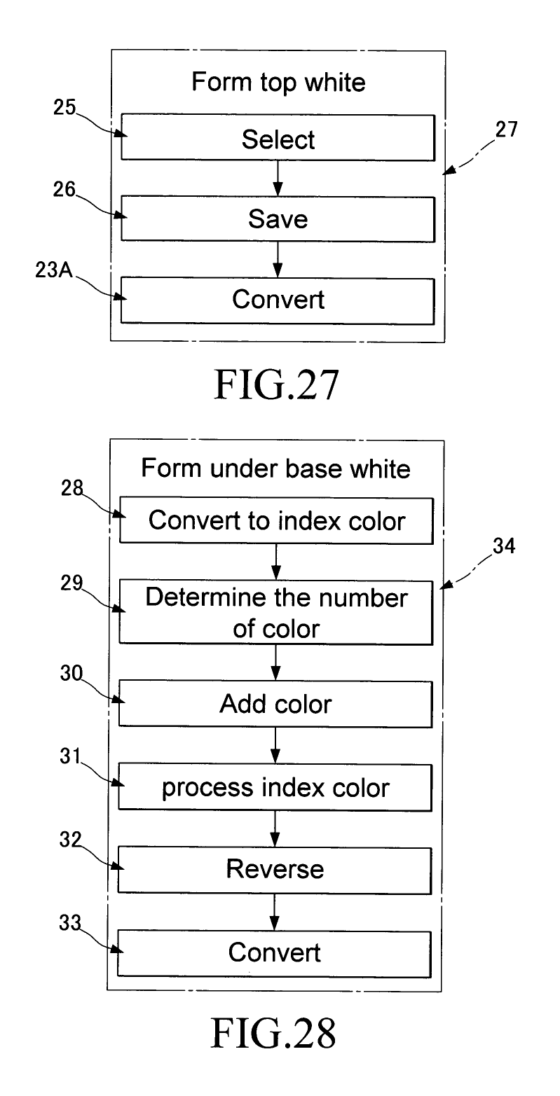

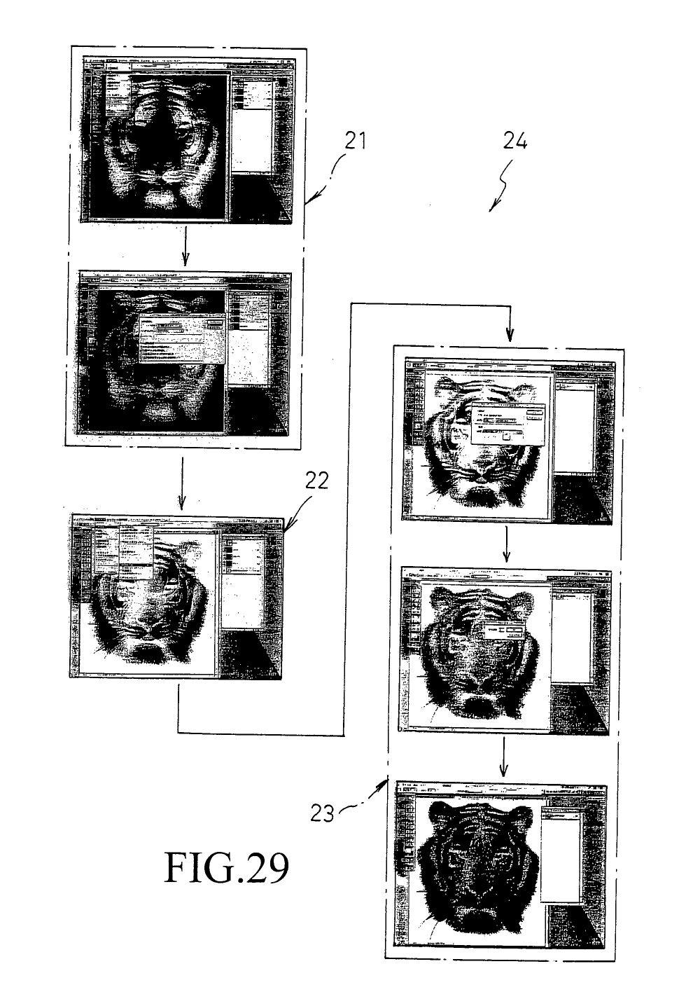

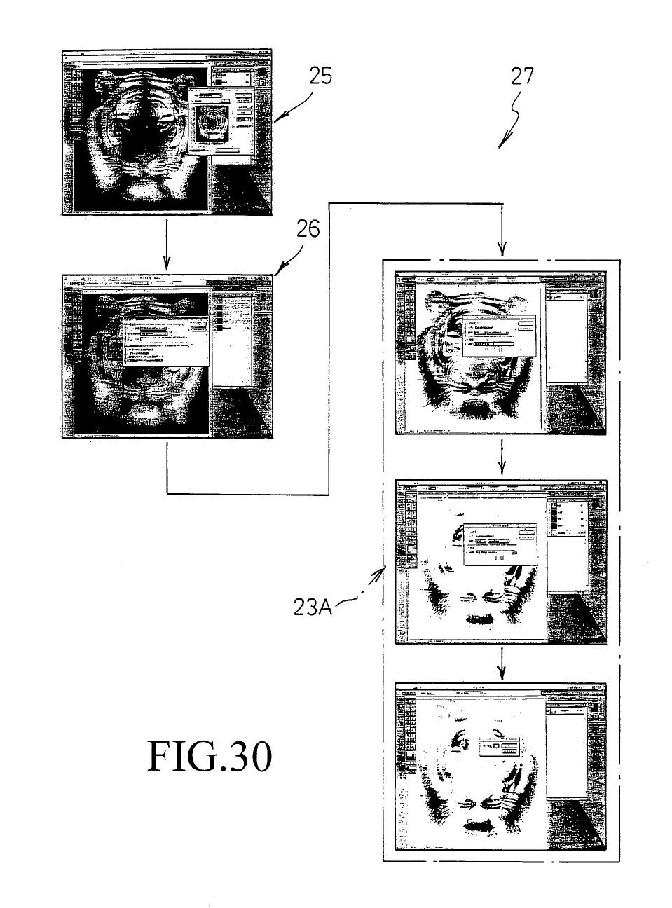

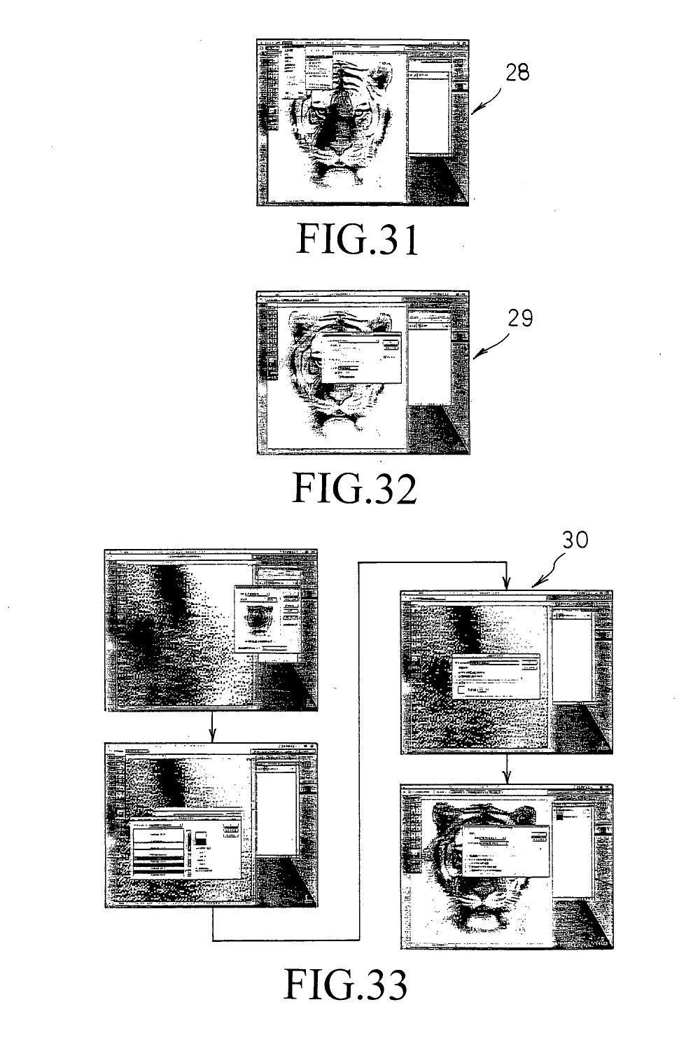

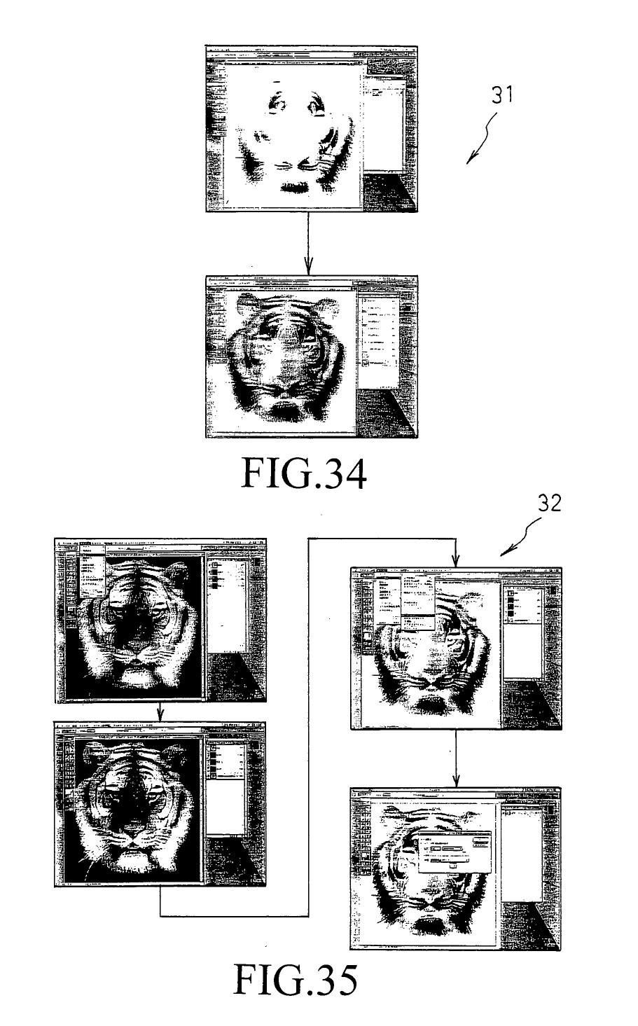

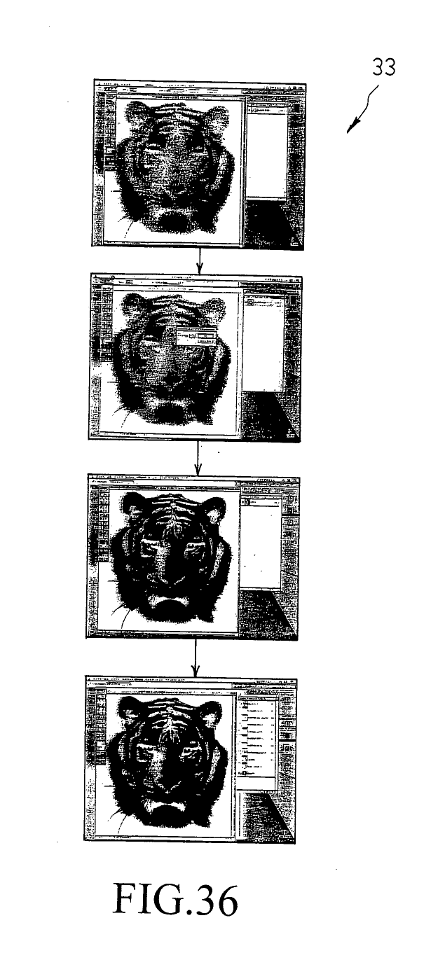

Other embodiments of the present invention will now be described with reference to FIGS. 7-36. In FIGS. 7-36, the same components as in the first embodiment described above with reference to FIGS. 7-36 are designated by the same reference numerals and therefore will not be further explained in great detail.

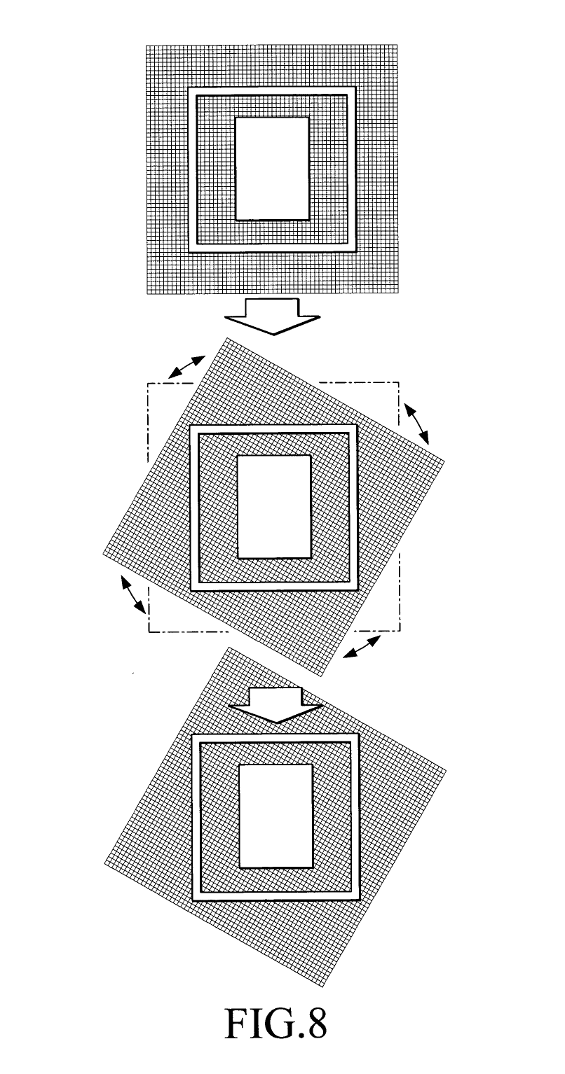

A second embodiment of the present invention is shown in FIGS. 7 and 8. It is distinguished from the first embodiment in that the formation process 7 is replaced from another process 7A. In the step 7A, when the delicate gap arises at the screen angle set up at the moire prevention step 1, both the screen 9 and the positive film 8 or either one is horizontally rotated to the angle which there is no the moire condition. Then the screen 9 is fixed to the frame 10 in the position (angle) that there is no the moire condition, and a screen plate 11A is formed. A screen plate 11A according to the second embodiment has similar advantages to that according to the first embodiment.

In addition, when the screen angle is not set up, the screen 9 may be horizontally rotated to the angle which the moire is lost, the screen 9 may be fixed to the frame 10 in the position (angle) which the moire is lost, and the screen plate 11A may be created.

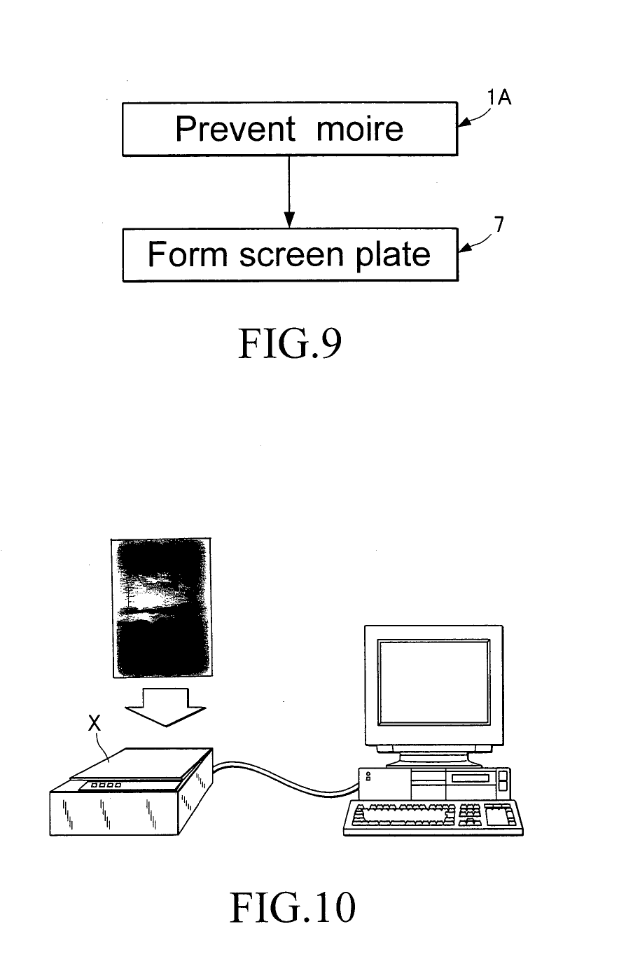

A third embodiment of the present invention is shown in FIGS. 9 to 14. It is distinguished from the first embodiment in that the moire prevention process 1 is replaced from another step 1A. In the moire prevention step 1A, the electronic correction processing is performed for the picture manuscript using the scanners X for making the plate and the like, and electronic data is processed suitably by the FM screen method which expresses a shade by the density without regularity of the dots infinitely formed. In the moire prevention step 1A, as shown in FIG. 10, In this moire prevention step 1A, the pattern as a manuscript is read with a scanner X as usual or the processed image data is used, and the data is divided by four colors as the printing colors by digital decomposition, that is, cyan 2, magenta 4, yellow 5 and black 3 (S1). Then each divided color is converted by a monochrome-two gray scale, and the input and output resolutions are set the same value, and a conversion system is set as the error conversion spreading method (dither) (S2). After each color is changed into gray scale, and the size ratio is set as “1” (S3), each color changed into the gray scale is specified, and it piles up as one frame (S4) and is printed by the screen 9 by controlling of the terminal.

Thus, since a screen plate 11B according to the second embodiment has similar advantages to that according to the first embodiment and can reduce the size of dot, it can prevent degradation of the quality-of-image by the moire efficiently and can print high resolution over the whole grayscale from a highlight to a shadow.

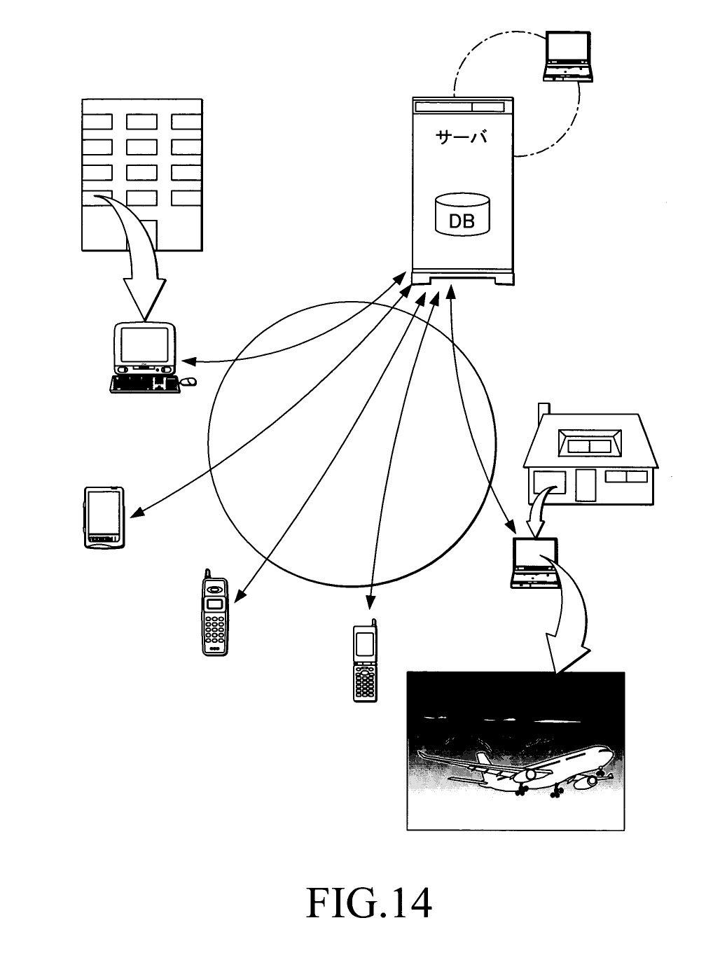

In addition, as shown in FIG. 14, when the server Y having an input-and output means, a control means to perform a system based on a main program, various databases (DB) which memorize image data information, customer information, etc. and memory means (memory part), etc is set suitably, and it is connected to the communications network Z through radio or the telephone line, so that it can received the image data at any time from consumer terminals including a plurality of the personal computers, a notebook typed PC, PDA, L-mode correspondence telephone, a portable telephone, and Internet-compatible household electric appliances which are connected through the communications network Z and the digital processing can be performed by the method of this embodiment. Therefore, it can be performed efficiently in a short time from data receipt to completion.

Furthermore, when the data obtained using electronic data processing is used as surface treatment information on the printed object, it combines with the conventional processing methods including the etching processing and sandblast processing so that the high resolution and high quality picture are reproducible to the printed object.

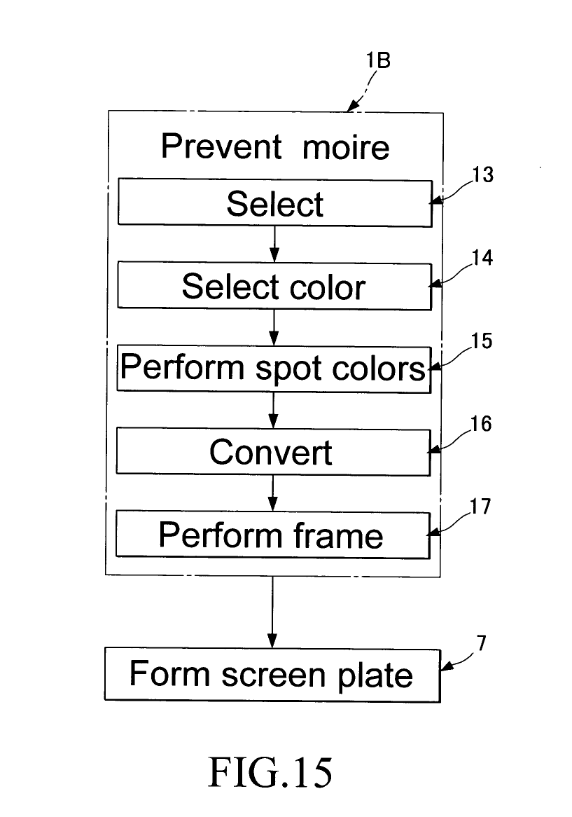

A fourth embodiment of the present invention is shown in FIGS. 15 to 20. It is distinguished from the third embodiment in that the moire prevention step 1 is replaced from another step 1B. In this moire prevention step 1B, the electronic data processing is performed by the special-color decomposition by the simulation. The moire prevention step 1B includes a step 13 for selecting, a step 14 for selecting colors, a step 15 for performing the spot colors, a step 16 for converting and a step 17 performing a frame.

In the selection step 13, each color is chosen via the simulation by a syringe tool in means for specifying the color range after a based picture (RGB) 12 as the original edition is reproduced by data-processing terminal.

In the color selection step 14, each color chosen at the selection step 13 is saved as a selection range, and the resemble color to the picture 12 is selected.

In the spot-color performing step 15, the color chosen and determined at the color selection step 14 transposes to a spot color.

In the conversion step 16, the state that is determined at the spot color-performing step 15 is saved according to each color, and it is converted to the monochrome-two gray scale after it is converted to the gray scale.

In the frame processing step 17, each color is selected and piled up as one frame after the color selection process 14, the spot color processing step 15, and the conversion step 16 are processed successively.

In the selection step 13, when each color is chosen, the maximum permissible quantity may be set up moderately, and automatic color range specification including red color, yellow color, green color, cyan color, blue color, magenta color, highlight, neutral colors, shadow, etc. may be used.

In the conversion step 16, the error conversion spreading method (dither) is used preferably, the setting value of the input resolution and output resolution is set up similarly, and it is performed.

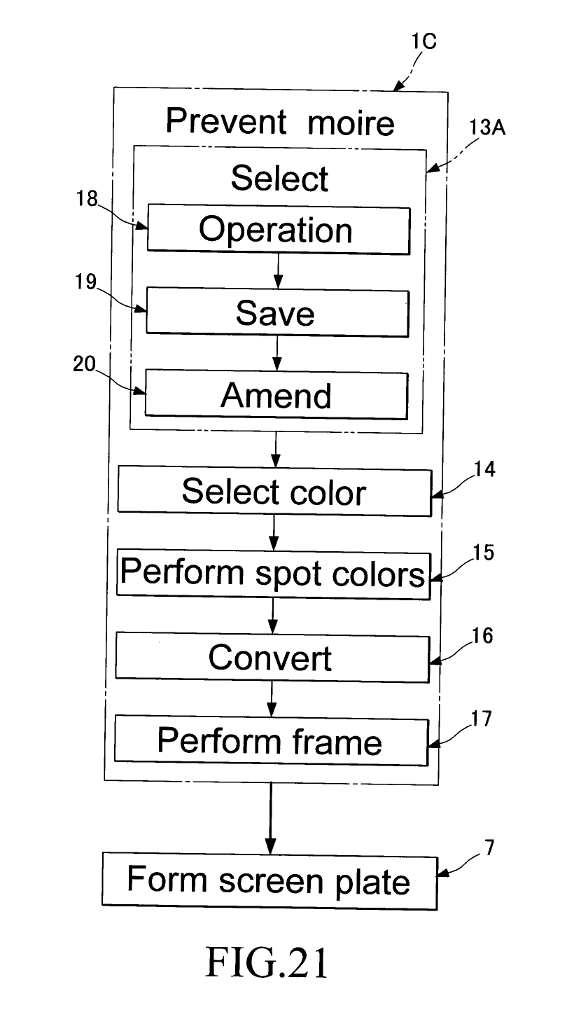

A fifth embodiment of the present invention is shown in FIGS. 21 to 24. It is distinguished from the fourth embodiment in that the selection process 13 is replaced from another selection process 13A that comprises of an operation step 18, a saving step 19 and an amendment step 20.

In the operation step 18, the reproduced picture is performed by the operation processing after a based picture (RGB) 12 as the original edition is reproduced by data-processing terminal.

In the saving step 19, each color is chosen, reversed the gradation, and saved at a new channel.

In the amendment step 20, the gradation of the image data saved at the step 19 is amended at level.

Thus, a moire prevention step 1C chooses each color and can processes so that the moire prevention process 1C according to the fifth embodiment has similar advantages to that according to the fourth embodiment.

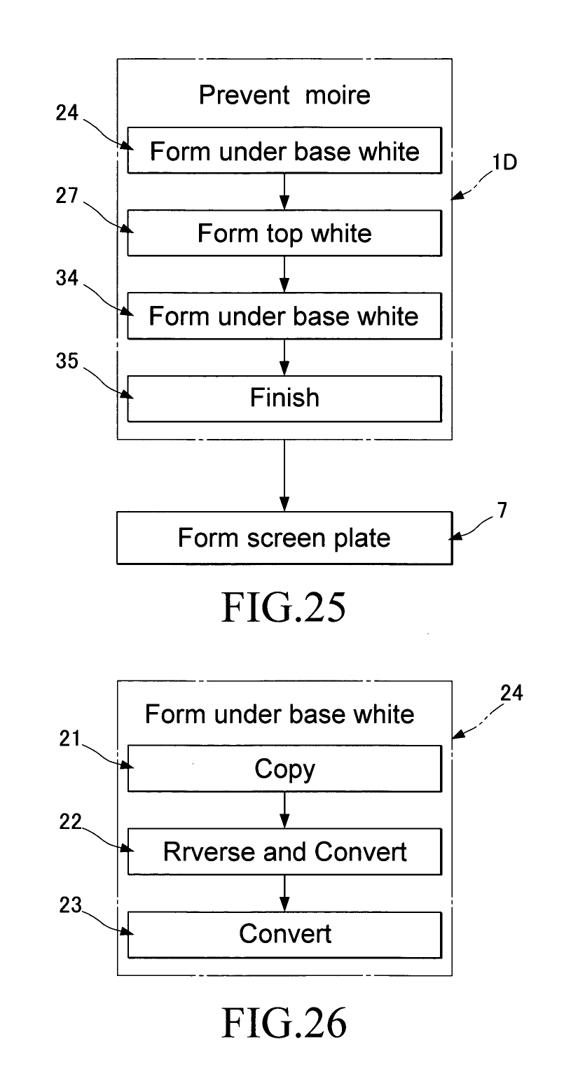

A sixth embodiment of the present invention is shown in FIGS. 25 to 36. It is distinguished from the fourth embodiment in that the moire prevention step s 1A is replaced from another process 1D. In the moire prevention process 1D, the electronic data processing is performed by the special-color decomposition of full color. The moire prevention step 1D is comprised of a step 24 for forming an under base white, a step 27 for forming an top white, a step 28 for converting to index color, a step 29 for determining the number of colors, a step 30 for adding the colors, a step 31 for processing the index color, a step 34 for forming an under base white and a step 35 for finishing.

The forming step 24 further includes a step 21 for coping and pasting the reproduced picture after the based picture (RGB) 12 as the original edition is reproduced by data-processing terminal, and a new channel is created; a step 22 for reversing and converting the picture pasted at this copy step 21; and a step 23 for converting the picture to the monochrome-two gray scale and gray, and save to another name, for example, under base white.

The forming step 27 further includes a step 25 for selecting the white of a highlight portion, at the same time, the white portion in a picture is specified after the based picture (RGB) 12 as the original edition is reproduced by data-processing terminal; a step 26 for saving the picture as a new channel created; a step 23A for converting the picture saved in the saving step to the monochrome-two gray scale and gray, and save to another name, for example, top white.

In the index color conversion process 28, the picture (RGB) 12 as the original edition is changed into an index color by the error conversion spreading method (dither), noise method or the pattern method, dither in this embodiment.

In the number determination process 29, the number of colors is determined of the picture changed in the index color conversion process 28.

In the color addition step 30, the picture processed in the number determination process 29 is specified at the color range, and each color is selected. Then each selected color is added to a new channel.

In the index color processing step 31, the top white and under base white saved in the top white forming step 27 and the under base white forming step 24 are added to the index color data after the color addition step 30 for every color is performed.

The under base white forming process 34 for utilizing the basic color further includes a step 32 for reversing; and a step 33 for converting. The reversing step 32 is performed to select the basic color (color of the background) from the picture (RGB) 12 and reverse the specified range. In the conversion step 33, the reversed picture is added to the new channel, and it performs the reversal conversion of gradation and is converted to the monochrome-two gray scale and gray scale.

The finish step 35 performs to add the under base white created in the under base white forming step 34 to the index color completed at the index color processing step 31.

When the base color is not printed, the moire prevention step 1D according to the sixth embodiment has similar advantages to that according to the fourth embodiment.

Furthermore, although each embodiment differs mainly explained based on the first embodiment, even if it uses the present invention combining the composition used for the form of not only this but each embodiment, the same action effect is acquired.

As set forth above, the advantages of the invention are as follows:

(1) A method for manufacturing of a screen plate including the screen printing plate, screen printing plate using an image, electronic stencil and the like in order to print the image to printed object, includes a step for preventing generating of a moire including moire fringes and a spot produced by piling up the formation which the point and line are distributed regularly and geometrically, one of setting a dot angle of printing colors needed for printing of the screen plate at a predetermined angle and matching a screen angle with the dot angle; and a step for forming the screen plate including a screen and a frame stretching the screen so that it can prevent certainly the generating of moire.

Therefore, it can print a picture with a lively motion and with high resolution.

(2) As discussed above, since it can prevent certainly the generating of moire, it can be manufactured the high utility value of a screen plate in the optimal state.

What is claimed is:

1. A method for manufacturing of a screen plate including the screen printing plate, screen printing plate using an image, electronic stencil and the like in order to print the image to printed object, comprising:
preventing generating of a moire including moire fringes and a spot produced by piling up the formation which the point and line are distributed regularly and geometrically, one of setting a dot angle of printing colors needed for printing of the screen plate at a predetermined angle and matching a screen angle with the dot angle; and
forming the screen plate including a screen and a frame stretching the screen.

2. A method for manufacturing of a screen plate according to claim 1, wherein the printing colors needed for printing of the screen plate is a yellow, magenta, black and cyan.

3. A method for manufacturing of a screen plate according to claim 1, wherein the dot angle of the moire preventing step is set alternatively at 6 to 8 degrees for yellow (Y), at 21 to 23 degrees for magenta (M), 51 to 53 degrees for black (K) and 79 to 81 degrees for cyan (C), capable of preventing the generation of the moire.

4. A method for manufacturing of a screen plate according to claim 1, wherein the moire-preventing step is performed to rotate the screen to a horizontal direction up to the position of no moire.

5. A method for manufacturing of a screen plate according to claim 1, wherein the moire-preventing step is performed to convert image data expressed the gradation by the size of dot to image data expressed the number of minute dot.

6. A method for manufacturing of a screen plate according to claim 1, wherein the image is downloaded to a computer as electronic data, processed an electronic retouch correction and the like to the data, and converting the correction processing data to dot data.

7. A screen plate comprising:
a screen arranged with a positive film, capable of preventing generating of a moire including moire fringes and a spot produced by piling up the formation which the point and line are distributed regularly and geometrically, one of setting a dot angle of printing colors needed for printing of the screen plate at a predetermined angle and matching a screen angle with the dot angle; and
a frame fixed the screen.
